(19) United States
(12) Patent Application Publication
(10) Pub. No.: US 2025/0203637 A1
(43) Pub. Date: Jun. 19, 2025

(54) USER EQUIPMENT AND CHANNEL ACCESS METHOD FOR SIDELINK COMMUNICATION

(71) Applicant: GUANGDONG OPPO MOBILE TELECOMMUNICATIONS CORP., LTD., Dongguan (CN)

(72) Inventor: Huei-Ming LIN, Taiwan (CN)

(21) Appl. No.: 19/071,415

(22) Filed: Mar. 5, 2025

Related U.S. Application Data
(63) Continuation of application No. PCT/CN2023/129770, filed on Nov. 3, 2023.
(60) Provisional application No. 63/422,677, filed on Nov. 4, 2022.

(51) Int. Cl. H04W 72/25; H04L 1/1812; H04L 5/00

(52) U.S. Cl. CPC H04W 72/25; H04L 1/1812; H04L 5/0055

(57) ABSTRACT

A channel access method for sidelink (SL) communication by a user equipment (UE) includes accessing, by the UE, a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst.

### CROSS-REFERENCE TO RELATED APPLICATIONS

This application is a Continuation Application of International Application No. PCT/CN2023/129770 filed Nov. 3, 2023, which claims priority to U.S. Provisional Application No. 63/422,677 filed Nov. 4, 2022. The entire contents of all of the above-identified applications are incorporated herein by reference in their entirety.

### TECHNICAL FIELD

The present disclosure relates to the field of communication systems, and more particularly, to a user equipment (UE) and a channel access method for sidelink (SL) communication, which can provide a good communication performance and/or provide high reliability.

### BACKGROUND

In the advancement of radio wireless transmission and reception directly between two devices, which is often known as device-to-device (D2D) communication, it is first developed by 3rd generation partnership project (3GPP) and introduced in Release 12 (officially specified as sidelink communication) and improved in Release 13 for public safety emergency usage such as mission critical communication to support mainly low data rate and voice type of connection. In 3GPP Releases 14, 15, and 16, the sidelink technology is advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology is further enhanced in Release 17 in power saving and transceiver link reliability. In Release 18, 3GPP further evolved the wireless technology and expanded its operation into unlicensed frequency spectrum. This is for larger available bandwidth, faster data transfer rate, and easier market adoption of D2D communication using sidelink without requiring any mobile cellular operator's involvement to allocate and configure a part of their expansive precious radio spectrum for data services that do not go throughput their mobile networks.

There is no base station control and assistance to sidelink (SL) UEs in accessing the unlicensed channel(s), even in resource allocation (RA) Mode 1 under a gNB scheduling, the UEs may try to access the channel at different time and using different LBT channel access procedure with different channel idle period requirement. Under this type of operating scenario, it is not possible to coordinate in advanced among the UEs transmitting in the same slot to avoid access blocking/denying to the unlicensed channel.

Therefore, there is a need for a user equipment (UE) and a channel access method for sidelink (SL) communication, which can solve issues in the prior art and other issues.

### SUMMARY

In a first aspect of the present disclosure, a channel access method for sidelink (SL) communication by a user equipment (UE) includes accessing, by the UE, a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst.

In a second aspect of the present disclosure, a user equipment (UE) includes an accessor configured to access a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst.

In a third aspect of the present disclosure, a user equipment (UE) includes a memory, a transceiver, and a processor coupled to the memory and the transceiver. The UE is configured to perform the above method.

In a fourth aspect of the present disclosure, a non-transitory machine-readable storage medium has stored thereon instructions that, when executed by a computer, cause the computer to perform the above method.

In a fifth aspect of the present disclosure, a chip includes a processor, configured to call and run a computer program stored in a memory, to cause a device in which the chip is installed to execute the above method.

In a sixth aspect of the present disclosure, a non-transitory computer readable storage medium, in which a computer program is stored, and the computer program, when executed by a processor of a user equipment (UE), causes the processor of the UE to execute the above method.

In a seventh aspect of the present disclosure, a computer program product includes a computer program, and the computer program causes a computer to execute the above method.

In an eighth aspect of the present disclosure, a computer program causes a computer to execute the above method.

### BRIEF DESCRIPTION OF DRAWINGS

In order to illustrate the embodiments of the present disclosure more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a channel access method for sidelink (SL) communication between user equipments (UEs) according to an embodiment of the present disclosure.

FIG. 5 is a schematic diagram illustrating a proposed channel access method for SL communication according to an embodiment of the present disclosure.

FIG. 6 is a block diagram of a UE for wireless communication according to an embodiment of the present disclosure.

FIG. 7 is a block diagram of an example of a computing device according to an embodiment of the present disclosure.

FIG. 8 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Shared/Unlicensed Spectrum

Shared (also referred as unlicensed or license-exempted) radio spectrum in 2.4 GHz and 5 GHz bands are commonly used by Wi-Fi and Bluetooth wireless technologies for short range communication (from just a few meters to few tens of meters). It is often claimed that more traffic is carried over the unlicensed spectrum bands than any other radio bands, since the frequency spectrum is free/at no-cost to use by anyone as long as the communication devices are compliant to certain local technical regulations. Besides Wi-Fi and Bluetooth, other radio access technologies (RATs) such as licensed-assisted access (LAA) based on 4G-LTE and new radio unlicensed (NR-U) based on 5G-NR mobile systems from 3GPP also operate in the same unlicensed bands. In order for devices of different RATs (Wi-Fi, Bluetooth, LAA, NR-U and possibly others) to operate simultaneously and coexistence fairly in the same geographical area without causing significant interference and interruption to each other's transmission, a clear channel access (CCA) protocol such as listen-before-talk (LBT) adopted in LAA and NR-U and carrier sense multiple access/collision avoidance (CSMA/CA) used in Wi-Fi and Bluetooth are employed before any wireless transmission is carried out to ensure that a wireless radio does not transmit while another is already transmitting on the same channel.

For the sidelink wireless technology, to also operate and coexistence with existing RATs already operating in the unlicensed bands, LBT based schemes may be employed to make certain there is no on-going activity on the radio channel before attempting to access the channel for transmission. For example, when a Type 1 LBT is successfully performed by a sidelink user equipment (UE), the UE has the right to access and occupy the unlicensed channel for a duration of a channel occupancy time (COT). During an acquired COT, however, a device of another RAT could still gain access to the channel if no wireless transmission is performed by the COT initiation sidelink UE or a COT responding sidelink UE for an idle period longer than 25 μs. Hence, potentially losing the access to the channel until another successful LBT is performed. A potential solution to this problem of losing the access to the channel could be a back-to-back (B2B) transmission.

### B2B Transmission/Multi-Consecutive Slots Transmission (MCSt)

The main purpose of B2B transmission (which can be also referred as “burst transmission” or “multi-consecutive slot transmission”) is intended for a sidelink (SL) communicating UE to occupy an unlicensed channel continuously for longer duration of time (i.e., more than one time slot) without a risk of losing the access to the channel to wireless transmission (Tx) devices of other radio access technologies (RATs). This can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. Therefore, when a UE finally has a chance/opportunity to gain access to the wireless channel for a channel occupancy time (COT) length which may last for a few milliseconds (e.g., 4 ms, 8 ms, or 10 ms).

Some embodiments of the present disclosure are to retain the channel access for as long as possible (e.g., all or most of the COT length) to send as much data as possible by continuously transmitting in the unlicensed channel such that wireless devices of other RATs would not have a chance to access the channel.

### Unlicensed Channel Access and Occupancy

As mentioned previously, a Type 1 LBT procedure can be perform by a UE before any SL transmission to first gain an access to an unlicensed channel and to initiate a COT. Additionally, a B2B transmission could be used to avoid large transmission gaps in order to retain the COT and the access to the channel. Beside the Type 1 LBT, a Type 2 LBT could be also used by the UE during a COT or a shared COT as required by unlicensed spectrum regulation for gaps that are 25 μs or smaller. For example, in a Type 2A LBT if an unlicensed channel is sensed to be idle for 25 μs or more, the COT initiating UE is permitted to resume its transmission and/or a COT sharing UE is allowed to start its transmission within a COT. In a Type 2B LBT, the allowed transmission gap is 16 μs and Type 2C LBT (for which the UE does not need to perform channel sensing) is for gaps less than 16 μs.

In NR-U and LAA system, transmission gaps are unavoidable/inevitable before UE occupying the unlicensed channel due to propagation delay between gNB/gNB to the UEs in sending scheduling control information, UE switching from a receiving mode (RX) to a transmitting mode (TX), and data information encoding and modulation for an actual uplink (UL) transmission. Sometimes, these gaps could be larger than 25 μs, and an extension of cyclic prefix may be first transmitted in the UL in order to avoid the unlicensed channel being taken over by other devices operating in the same spectrum band due to excessive channel idle time). The duration of the cyclic prefix extension (CPE) transmission in the UL is determined by the base station (gNB/eNB) to avoid any access blocking/denying issue among different UEs and it is indicated to each scheduled UE, and the UE simply follows the indication and performs UL transmission accordingly.

In SL communication, especially in resource allocation (RA) Mode 2, all transmission resources are to be determined and selected by the UE on its own without any base station intervention, assistance, and coordination to avoid transmission collisions. Furthermore, the SL system enables frequency domain multiplexing (FDM) of transmissions from multiple UEs in the same slot such that radio resource utilization efficiency is maximized and shortened the communication latency at the same time. But since there is no base station control and assistance to SL UEs in accessing the unlicensed channel(s), even in RA Mode 1 under a gNB scheduling, the UEs may try to access the channel at different time and using different LBT channel access procedure with different channel idle period requirement. Under this type of operating scenario, it is not possible to coordinate in advanced among the UEs transmitting in the same slot to avoid access blocking/denying to the unlicensed channel.

### Contention Window Adjustment

As part of the Type 1 LBT channel access procedure, depending on the channel access priority class (CAPC) level (p) of the data packet, physical channel and/or signal to be transmitted, the range of required LBT sensing time lengths before a UE is able to gain access to the shared/unlicensed are different. In order to determine the exact LBT sensing time length within the range for a given CAPC level (p) and a particular transmission, the maximum allowable value for the channel sensing time is further adjusted based on a “channel contention status”, which is measured according to hybrid automatic repeat request-acknowledgement (HARQ-ACK) feedbacks from the data receiver node. In NR-U, the contention window adjustment procedures are mostly based on a number of ‘ACK’ feedbacks received in relation to a reference duration and unicast transmission.

In NR sidelink communication, however, cast types and HARQ-ACK feedback mechanisms for physical sidelink shared channel (PSSCH) transmissions carrying information data packets can be very different to NR-U (e.g., code block group transmission is not supported, and HARQ-ACK feedbacks are not always enabled/available in SL). Therefore, a new definition and adjustment procedures for the SL-U contention window is necessary.

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR releases 19 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

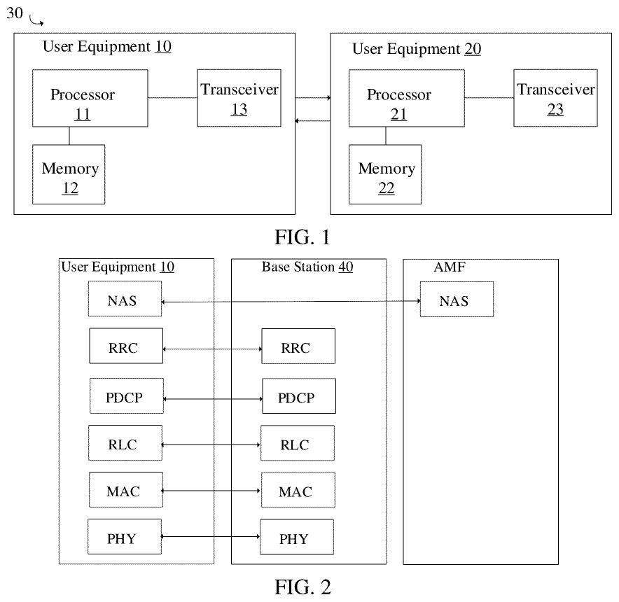

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologies and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

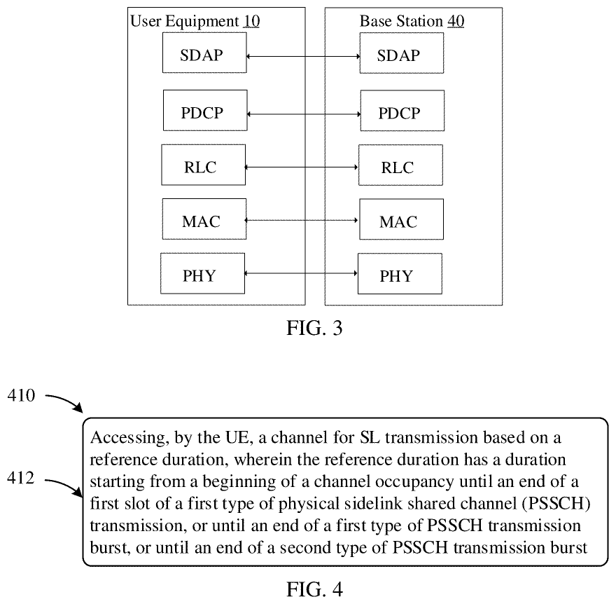

FIG. 3 illustrates an example control plane protocol stack according to an embodiment of the present disclosure. FIG. 3 illustrates that, in some embodiments, in the control plane protocol stack where PDCP, RLC, and MAC layers and PHY layer may be terminated in a UE 10 and a base station 40 (such as gNB) on a network side and perform service and functions described above. In an example, radio resource control (RRC) used to control a radio resource between the UE and a base station (such as a gNB). In an example, RRC may be terminated in a UE and the gNB on a network side. In an example, services and functions of RRC may comprise broadcast of system information related to access stratum (AS) and non-access stratum (NAS), paging initiated by 5G core network (5GC) or radio access network (RAN), establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an access and mobility management function (AMF) for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to access a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst. This can solve issues in the prior art and other others, and/or improve SL communication performance and reliability.

FIG. 4 illustrates a method 410 for channel access and occupancy in a shared spectrum between user equipments (UEs) according to an embodiment of the present disclosure. In some embodiments, the method 410 includes: an operation 412, accessing, by the UE, a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst. This can solve issues in the prior art and other others, and/or improve SL communication performance and reliability.

In some embodiments, the first type of PSSCH transmission includes a hybrid automatic repeat request (HARQ) enabled PSSCH transmission. In some embodiments, an enabled/disabled indicator for HARQ feedback is in a second stage sidelink control information (SCI) scheduling the first type of PSSCH transmission indicating HARQ enabled. In some embodiments, the first type of PSSCH transmission includes a unicast PSSCH transmission. In some embodiments, the first type of PSSCH transmission includes a groupcast PSSCH transmission. In some embodiments, the groupcast PSSCH transmission includes a groupcast option 2 transmission with an acknowledgement (ACK) or negative acknowledgement (NACK) feedback or a groupcast option 1 transmission with a NACK-only feedback.

In some embodiments, a bit field in a second stage SCI scheduling the first type of PSSCH transmission is a first value indicating a groupcast option 2 transmission with an ACK or NACK feedback, a second value indicating a unicast transmission, or a third value indicating a groupcast option 1 transmission with a NACK-only feedback. In some embodiments, the first value is 01, the second value is 10, and/or the third value is 11. In some embodiments, the first type of PSSCH transmission is transmitted in a resource pool, and the resource pool is configured with physical sidelink feedback channel (PSFCH) resources. In some embodiments, the channel occupancy is initialized by the UE using a Type 1 channel access procedure.

In some embodiments, the channel occupancy is used for transmitting a PSSCH transmission. In some embodiments, the first type of PSSCH transmission burst includes one or multiple first type of PSSCH transmissions. In some embodiments, the one or multiple first type of PSSCH transmissions includes one or multiple unicast PSSCH transmissions, one or multiple groupcast PSSCH transmissions, or one or multiple broadcast PSSCH transmissions. In some embodiments, the second type of PSSCH transmission burst includes one or multiple second type of PSSCH transmissions. In some embodiments, the one or multiple second type of PSSCH transmissions includes one or multiple broadcast PSSCH transmissions.

In some embodiments, a bit field in a second stage SCI scheduling the second type of PSSCH transmission is a fourth value indicating a broadcast transmission. In some embodiments, the fourth value is 00. In some embodiments, the one or multiple second type of PSSCH transmissions includes one or multiple HARQ disabled PSSCH transmissions. In some embodiments, an enabled/disabled indicator for HARQ feedback is in a second stage SCI scheduling the one or multiple second type of PSSCH transmissions indicating HARQ disabled. In some embodiments, the one or multiple second type of PSSCH transmissions are transmitted in a resource pool, and the resource pool is not configured with PSFCH resources.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

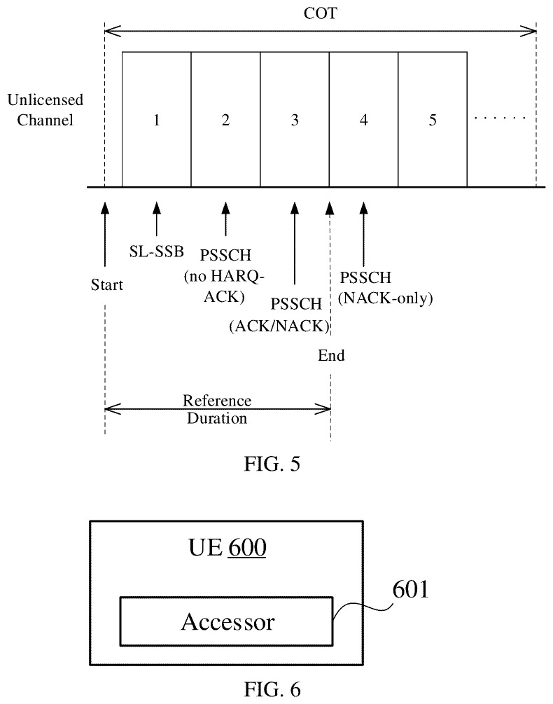

FIG. 5 illustrates a proposed channel access method for SL communication according to an embodiment of the present disclosure. FIG. 5 illustrates that, in some embodiments, in an inventive method for accessing an unlicensed/shared channel in sidelink (SL) communication, the method proposes defining a reference duration that is tailored for sidelink taking into account of all possible hybrid automatic repeat and request-acknowledgement (HARQ-ACK) feedback scenarios in SL communication.

As mentioned earlier, the code block group (CBG) based transmissions and HARQ-ACK feedback schemes used in the 5th generation (5G) new radio (NR) are not adopted in NR SL communication. Furthermore, for a NR system operating in an unlicensed carrier (NR-U), the majority of traffic in both downlink (DL) and uplink (UL) transmissions (e.g., more than 95%) is unicast in nature. Occasionally, broadcast transmissions such as synchronization signal blocks (SSBs) and system information blocks (SIBs) are provided in DL, and random-access channel (RACH) in UL. As a special case, SSBs can be transmitted using only a Type 2A channel access procedure. As such, Type 1 channel access procedures are performed in about all cases for unicast transmissions which always require HARQ-ACK feedback of either ‘ACK’ or ‘NACK’ from the receiver UE/gNB.

FIG. 5 illustrates that, in sidelink communication, various transmission cast types and HARQ-ACK feedback schemes are supported, such as broadcast transmission requires no HARQ-ACK feedback, groupcast transmission with full HARQ-ACK feedback (‘ACK and NACK’) and ‘NACK-only’ feedback, and unicast with full HARQ-ACK feedback (‘ACK and NACK’). In addition, a SL transmission resource pool can be configured with no physical sidelink feedback channel (PSFCH) resources and in this case all transmissions in the resource pool do not require/receive any HARQ-ACK feedback. To make the SL operation even more complicated, sidelink HARQ-ACK feedback can be enabled/disabled in a 2nd stage sidelink control information (SCI) scheduling a physical sidelink shared channel (PSSCH) for both groupcast and unicast transmissions. As can be seen, there are more than just one HARQ-ACK scenario supported in SL communication. Therefore, the existing adjustment of contention window for Type 1 channel access procedures is not suitable and cannot be applied to SL communication to access an unlicensed/shared channel.

### Proposed Reference Duration Definition

In order to take into account of all possible SL operating scenarios, it is proposed to define the reference duration (or SL-specific reference duration) as:

In some embodiments, the reference duration for SL has a duration starting from the beginning of the channel occupancy time (COT) until the end of the first slot of the first type of PSSCH transmission, or until the end of the first type of PSSCH transmission burst, or until the end of the second type of PSSCH transmission burst. Optionally, the first type of PSSCH may be unicast or groupcast PSSCH. Optionally, the first type of PSSCH may be unicast PSSCH.

In some embodiments, the first type of PSSCH may be a groupcast PSSCH based on one of the followings. Exemplarily, the groupcast PSSCH may be groupcast option 2 with ACK-or-NACK feedback or groupcast option 1 with NACK-only feedback. Exemplarily, the groupcast PSSCH may be groupcast option 2 with ACK-or-NACK feedback. Exemplarily, the groupcast PSSCH may be groupcast option 1 with NACK-only feedback. Exemplarily, the bit field of the case type in a 2nd stage SCI scheduling the first type of PSSCH is 01 (groupcast option 2 with ACK-or-NACK feedback) or 10 (unicast) or 11 (groupcast option 1 with NACK-only feedback). Optionally, the first type of PSSCH may be a HARQ enabled PSSCH. Exemplarily, the enabled/disabled indicator for the HARQ feedback is in the 2nd stage SCI scheduling the first type of PSSCH indicating HARQ enabled. Optionally, the resource pool in which the first type of PSSCH is being transmitted is (pre-) configured with PSFCH resources. Optionally, the COT is initialized by a UE via a Type 1 channel access procedure. Optionally, the COT is used for transmitting PSSCH.

Optionally, the first type of PSSCH transmission burst includes one or multiple first type of PSSCH. Exemplarily, the first type of PSSCH transmission burst includes one or multiple unicast or groupcast PSSCH transmissions, and one or multiple broadcast PSSCH transmissions.

Optionally, the second type of PSSCH transmission burst includes one or multiple second type of PSSCH. Exemplarily, the second type of PSSCH transmission burst includes only broadcast PSSCH. Optionally, the second type of PSSCH is a broadcast PSSCH. Exemplarily, the bit field of the case type in a 2nd stage SCI scheduling the second type of PSSCH is 00 (broadcast) Optionally, the second type of PSSCH is a HARQ disabled PSSCH. Exemplarily, the enabled/disabled indicator for the HARQ feedback is in the 2nd stage SCI scheduling the second type of PSSCH indicating HARQ disabled. Optionally, the resource pool in which the second type of PSSCH is being transmitted is not (pre-) configured with PSFCH resources.

Note that, the term “pre-defined” or “pre-defined rules” in the present disclosure may be achieved by pre-storing corresponding codes, tables or other manners for indicating relevant information in devices (e.g., including a UE and a network device). The implementation is not limited in the present disclosure. For example, “pre-defined” may refer to those defined in a protocol. It is also to be understood that in the disclosure, “protocol” may refer to a standard protocol in the field of communication, which may include, for example, a (long term evolution) LTE protocol, (new ratio) NR protocol and relevant protocol applied in the future communication system, which is not limited in the present disclosure.

FIG. 6 illustrates a UE 600 for wireless communication according to an embodiment of the present disclosure. The UE 600 includes an accessor 601 configured to access a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst. This can solve issues in the prior art and other others, and/or improve SL communication performance and reliability.

In some embodiments, the first type of PSSCH transmission includes a hybrid automatic repeat request (HARQ) enabled PSSCH transmission. In some embodiments, an enabled/disabled indicator for HARQ feedback is in a second stage sidelink control information (SCI) scheduling the first type of PSSCH transmission indicating HARQ enabled. In some embodiments, the first type of PSSCH transmission includes a unicast PSSCH transmission. In some embodiments, the first type of PSSCH transmission includes a groupcast PSSCH transmission. In some embodiments, the groupcast PSSCH transmission includes a groupcast option 2 transmission with an acknowledgement (ACK) or negative acknowledgement (NACK) feedback or a groupcast option 1 transmission with a NACK-only feedback.

In some embodiments, a bit field in a second stage SCI scheduling the first type of PSSCH transmission is a first value indicating a groupcast option 2 transmission with an ACK or NACK feedback, a second value indicating a unicast transmission, or a third value indicating a groupcast option 1 transmission with a NACK-only feedback. In some embodiments, the first value is 01, the second value is 10, and/or the third value is 11. In some embodiments, the first type of PSSCH transmission is transmitted in a resource pool, and the resource pool is configured with physical sidelink feedback channel (PSFCH) resources. In some embodiments, the channel occupancy is initialized by the UE using a Type 1 channel access procedure.

In some embodiments, the channel occupancy is used for transmitting a PSSCH transmission. In some embodiments, the first type of PSSCH transmission burst includes one or multiple first type of PSSCH transmissions. In some embodiments, the one or multiple first type of PSSCH transmissions includes one or multiple unicast PSSCH transmissions, one or multiple groupcast PSSCH transmissions, or one or multiple broadcast PSSCH transmissions. In some embodiments, the second type of PSSCH transmission burst includes one or multiple second type of PSSCH transmissions. In some embodiments, the one or multiple second type of PSSCH transmissions includes one or multiple broadcast PSSCH transmissions.

In some embodiments, a bit field in a second stage SCI scheduling the second type of PSSCH transmission is a fourth value indicating a broadcast transmission. In some embodiments, the fourth value is 00. In some embodiments, the one or multiple second type of PSSCH transmissions includes one or multiple HARQ disabled PSSCH transmissions. In some embodiments, an enabled/disabled indicator for HARQ feedback is in a second stage SCI scheduling the one or multiple second type of PSSCH transmissions indicating HARQ disabled. In some embodiments, the one or multiple second type of PSSCH transmissions are transmitted in a resource pool, and the resource pool is not configured with PSFCH resources.

In some embodiments, the term “/” can be interpreted to indicate “and/or.” The term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

In summary, in some embodiments, in order to take into account of all possible SL operating scenarios, it is proposed to define the reference duration (or SL-specific reference duration) as: In some embodiments, the SL reference duration has a duration starting from the beginning of the channel occupancy until the end of the first slot of the first type of PSSCH transmission, or until the end of the first type of PSSCH transmission burst, or until the end of the second type of PSSCH transmission burst. Optionally, the first type of PSSCH may be unicast or groupcast PSSCH. Optionally, the first type of PSSCH may be unicast PSSCH.

Commercial interests for some embodiments are as follows. 1. Solving issues in the prior art and other issues. 2. Improving a sidelink (SL) communication performance. 3. Access to the unlicensed channel is maintained for the intended SL transmission. 4. Avoiding SL transmission collision in the case when the intended SL transmission occupies at least full bandwidth of a channel based on a priority-based access. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed application and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, 19, and beyond for providing direct device-to-device (D2D) wireless communication services.

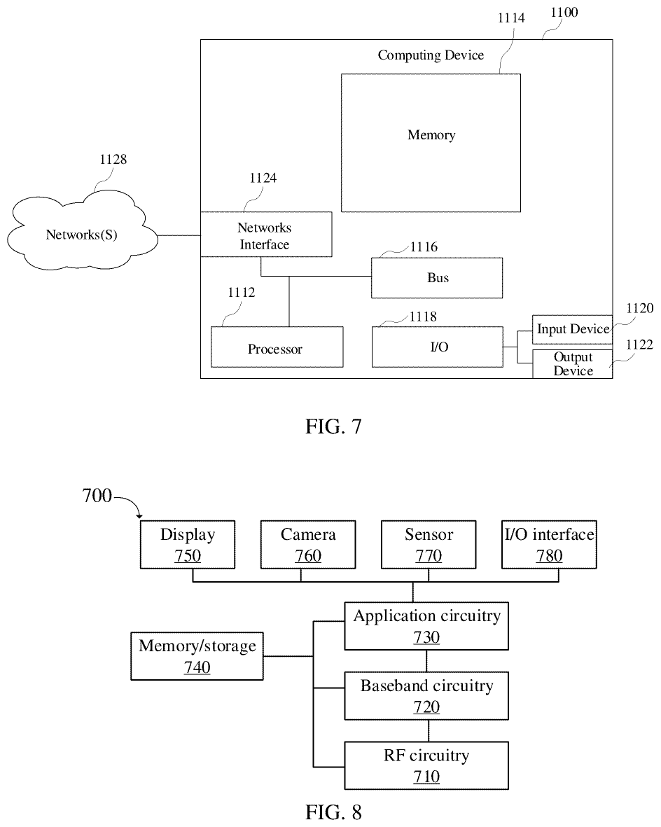

FIG. 7 is a block diagram of an example of a computing device according to an embodiment of the present disclosure. Any suitable computing device can be used for performing the operations described herein. For example, FIG. 7 illustrates an example of the computing device 1100 that can implement some embodiments in FIG. 1 to FIG. 6, using any suitably configured hardware and/or software. In some embodiments, the computing device 1100 can include a processor 1112 that is communicatively coupled to a memory 1114 and that executes computer-executable program code and/or accesses information stored in the memory 1114. The processor 1112 may include a microprocessor, an application-specific integrated circuit (“ASIC”), a state machine, or other processing device. The processor 1112 can include any of a number of processing devices, including one. Such a processor can include or may be in communication with a non-transitory computer-readable medium storing instructions that, when executed by the processor 1112, cause the processor to perform the operations described herein.

The memory 1114 can include any suitable non-transitory computer-readable medium. The non-transitory computer-readable medium can include any electronic, optical, magnetic, or other storage device capable of providing a processor with computer-readable instructions or other program code. Non-limiting examples of a non-transitory computer-readable medium include a magnetic disk, a memory chip, a read-only memory (ROM), a random access memory (RAM), an application specific integrated circuit (ASIC), a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C #, visual basic, java, python, perl, javascript, and actionscript.

The computing device 1100 can also include a bus 1116. The bus 1116 can communicatively couple one or more components of the computing device 1100. The computing device 1100 can also include a number of external or internal devices such as input or output devices. For example, the computing device 1100 is illustrated with an input/output (“I/O”) interface 1118 that can receive input from one or more input devices 1120 or provide output to one or more output devices 1122. The one or more input devices 1120 and one or more output devices 1122 can be communicatively coupled to the I/O interface 1118. The communicative coupling can be implemented via any suitable manner (e.g., a connection via a printed circuit board, connection via a cable, communication via wireless transmissions, etc.). Non-limiting examples of input devices 1120 include a touch screen (e g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 1122 include a liquid crystal display (LCD) screen, an external monitor, a speaker, or any other device that can be used to display or otherwise present outputs generated by a computing device.

The computing device 1100 can execute program code that configures the processor 1112 to perform one or more of the operations described above with respect to FIG. 1 to FIG. 6. The program code may be resident in the memory 1114 or any suitable non-transitory computer-readable medium and may be executed by the processor 1112 or any other suitable processor.

The computing device 1100 can also include at least one network interface device 1124. The network interface device 1124 can include any device or group of devices suitable for establishing a wired or wireless data connection to one or more data networks 1128. Non limiting examples of the network interface device 1124 include an Ethernet network adapter, a modem, and/or the like. The computing device 1100 can transmit messages as electronic or optical signals via the network interface device 1124.

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a non-transitory readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a non-transitory storage medium, including a plurality of commands for a computational device (such as a personal computer, a server, or a network device) to run all or some of the steps disclosed by the embodiments of the present disclosure. The non-transitory storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A channel access method for sidelink (SL) communication by a user equipment (UE), comprising:
accessing, by the UE, a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst.

2. The method of claim 1, wherein the first type of PSSCH transmission comprises a hybrid automatic repeat request (HARQ) enabled PSSCH transmission.

3. The method of claim 2, wherein an enabled/disabled indicator for HARQ feedback is in a second stage sidelink control information (SCI) scheduling the first type of PSSCH transmission indicating HARQ enabled.

4. The method of claim 1, wherein the first type of PSSCH transmission comprises a unicast PSSCH transmission.

5. The method of claim 1, wherein the first type of PSSCH transmission comprises a groupcast PSSCH transmission.

6. The method of claim 5, wherein the groupcast PSSCH transmission comprises a groupcast option 2 transmission with an acknowledgement (ACK) or negative acknowledgement (NACK) feedback or a groupcast option 1 transmission with a NACK-only feedback.

7. The method of claim 5, wherein a bit field in a second stage SCI scheduling the first type of PSSCH transmission is a first value indicating a groupcast option 2 transmission with an ACK or NACK feedback, a second value indicating a unicast transmission, or a third value indicating a groupcast option 1 transmission with a NACK-only feedback.

8. The method of claim 7, wherein the first value is 01, the second value is 10, and/or the third value is 11.

9. The method of claim 1, wherein the first type of PSSCH transmission is transmitted in a resource pool, and the resource pool is configured with physical sidelink feedback channel (PSFCH) resources.

10. The method of claim 1, wherein the channel occupancy is initialized by the UE using a Type 1 channel access procedure.

11. The method of claim 1, wherein the channel occupancy is used for transmitting a PSSCH transmission.

12. The method of claim 1, wherein the first type of PSSCH transmission burst comprises one or multiple first type of PSSCH transmissions.

13. The method of claim 12, wherein the one or multiple first type of PSSCH transmissions comprises one or multiple unicast PSSCH transmissions, one or multiple groupcast PSSCH transmissions, or one or multiple broadcast PSSCH transmissions.

14. A user equipment (UE), comprising:
a memory;
a transceiver; and
a processor coupled to the memory and the transceiver;
wherein the UE is configured to perform:
accessing a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst.

15. The UE of claim 14, wherein the first type of PSSCH transmission comprises a hybrid automatic repeat request (HARQ) enabled PSSCH transmission; wherein an enabled/disabled indicator for HARQ feedback is in a second stage sidelink control information (SCI) scheduling the first type of PSSCH transmission indicating HARQ enabled.

16. The UE of claim 14, wherein the first type of PSSCH transmission comprises a unicast PSSCH transmission.

17. The UE of claim 14, wherein the first type of PSSCH transmission comprises a groupcast PSSCH transmission; wherein the groupcast PSSCH transmission comprises a groupcast option 2 transmission with an acknowledgement (ACK) or negative acknowledgement (NACK) feedback or a groupcast option 1 transmission with a NACK-only feedback.

18. The UE of claim 14, wherein the first type of PSSCH transmission is transmitted in a resource pool, and the resource pool is configured with physical sidelink feedback channel (PSFCH) resources; wherein the channel occupancy is initialized by the UE using a Type 1 channel access procedure.

19. The UE of claim 14, wherein the first type of PSSCH transmission burst comprises one or multiple first type of PSSCH transmissions; wherein the one or multiple first type of PSSCH transmissions comprises one or multiple unicast PSSCH transmissions, one or multiple groupcast PSSCH transmissions, or one or multiple broadcast PSSCH transmissions.

20. A computer readable storage medium, in which a computer program is stored, wherein the computer program, when executed by a processor of a user equipment (UE), causes the processor of the UE to perform: accessing a channel for SL transmission based on a reference duration, wherein the reference duration has a duration starting from a beginning of a channel occupancy until an end of a first slot of a first type of physical sidelink shared channel (PSSCH) transmission, or until an end of a first type of PSSCH transmission burst, or until an end of a second type of PSSCH transmission burst.
